(19) United States
(12) Patent Application Publication
(10) Pub. No.: US 2011/0012037 A1
(43) Pub. Date: Jan. 20, 2011

(54) Noise reducing valve for toilet systems

(76) Inventor: Antonio Martin Galvez-Ramos, Wellington, FL (US)

Correspondence Address: Antonio Martin Galvez-Ramos, 15105 Cedar Bluff Place, Wellington, FL, 33414, US

(21) Appl. No.: 12/807,939

(22) Filed: Sep. 18, 2010

Related U.S. Application Data
(63) Continuation-in-part of application No. 12/661,295, filed on Mar. 15, 2010.
Application No. 12/661,295 is a continuation-in-part of application No. 11/803,789, filed on Jul. 3, 2007.

(51) Int. Cl. F16L 55/02

(52) U.S. Cl. 251/118

(57) ABSTRACT

Providing a noise reducing water valve, intended to be installed inside the bottom piece of an existing flush valve installed in a toilet as a retrofit or built-in inside a new flush valve, in order to reduce and control the unnecessary and excessive water flow present in a noisy toilet.

High levels of noise are found on regular toilets when excessive water flow and water pressure are used during the flushing of the units. By limiting the amount of water that enters the toilet bowl through the flush valve, while still allowing sufficient water for a good flush of the unit, we will control the noise generated by the run of the water from the toilet tank to the toilet drain.

The noise reducing valve will have a key component which is a flow disc reducer piece that will come in different opening sizes, to be inserted inside the said valve, in order to find the most suitable flush water flow for fine tuning each toilet.

### FIELD OF THE INVENTION

The present invention relates to a noise reducing valve for toilet systems and more particularly to a noise reducing valve that will control the amount of flush water that the flush valve will allow into the toilet bowl during flushing action.

### BACKGROUND OF THE INVENTION

A common problem when flushing a toilet after using it, is the potential loud noise level produced by some of them, due to the high pressure of water while traveling from the toilet tank through the toilet jets into the toilet drain. There is even sometimes, an annoying splashing produced during this process, as most toilets and toilet flush valve manufacturers are more concern with a strong flush water flow, rather than with a smooth flush water flow that will do the same job.

This flushing noise could be so loud and even embarrassing, that during late hours of the night when people are enjoying their sleep time, it will awake many light sleepers and especially babies.

Once a person awakes at night it might take them some time to go back to deep sleep or in some cases, will not even be possible as some of them might have difficulties falling sleep again.

Unfortunately some people might experience the need to use the toilet during the late hours of the night and face the dilemma of not flushing the toilet after using it, or waking the people in their homes if they flush their toilets.

The present invention addresses this problem with a very economical, small and even portable noise reducing valve that can be installed by any person without any training in a matter of minutes.

As toilets go even though they might look similar and be produced by the same manufacturer, they can have different water flow pressures and jets shapes, therefore different noise levels. That is why fine tuning might be required for best results for each particular preference in water pressure and noise level. And in case of change of a heart, it could also be pull out extremely fast and easy, and be re-used in another location or a hotel where many times we find noisy toilets very close to our beds.

Controlling the toilet flushing water flow and pressure with easiness and economically is key, and that is exactly what this valve does.

### SUMMARY OF THE INVENTION

It is the goal of the present invention to provide a noise reducing toilet valve that can be easily installed in a toilet. The valve will control the water flow pressure during the flush operation of the unit, in such a way that the end result is a toilet that still performs as expected, but its noise emissions will be cut down substantially.

In order to achieve this result without having to interfere with the flushing system or having to incur major work, a good place for the valve would be inside the bottom part of the flush valve (which interconnects the toilet tank with the toilet bowl). This area is hidden from view and does not take any room in the toilet tank (a different position could also be used).

Because the bottom part of the toilet's flush valve has a cylindrical shape, our valve will have the very same shape in its outside so it does not conflict with the toilet's flush valve. In order to hold this noise reducing toilet valve in place (inside the flush valve) its partial side of the wall has been extended downwards so it can reach the toilet bowl and provide support to itself.

Now in order to control the water flow that comes down from the water tank when the flush valve's flapper opens, a flow disc reducer has been inserted inside the noise reducing valve. This flow disc reducer is basically a flat disc with a central circular hole. This opening area of the flow disc reducer will allow less water flow to pass through the noise reducing valve.

The flow disc reducer will sit on top of a circular ring support, which is solidly attached to the inner wall of the cylindrical body of the noise reducing valve. This will allow the flow disc reducer to sit on it and not fall into the toilet bowl.

We could also use other methods on how to secure the flow disc reducer to the noise reducing valve, such as by several single or even interconnected brackets in the inner wall of the noise reducing valve.

Now in order to have the right water flow pressure for each toilet, a different water flow disc reducer will have to be inserted. The bigger the opening inside the disc, the more water flow will be allowed inside the toilet bowl, and the smaller the opening in the flow disc reducer, the less flush water flow will be allowed inside the toilet bowl.

The jets of the toilet bowl play a key factor as a lot of noise is produced here when the water exits them and hits the toilet bowl on its way to the drain.

For new flush valves installations we could assemble the noise reducing valve already built-in inside the cylindrical bottom piece (neck) of the flush valve, by adding some supports inside the inner wall of the neck in a circular fashion and placing the flow disc reducer on top.

### BRIEF DESCRIPTION OF THE DRAWINGS

FIG. 1 is a front cross-sectional view of a toilet during the flushing action showing the interconnection of the flush valve between the toilet tank and the toilet bowl along with a strong water flow.

FIG. 2 is a side cross-sectional view of a toilet during the flushing action showing the interconnection of the flush valve between the toilet tank and the toilet bowl along with a strong water flow.

FIG. 3 is a perspective view of the noise reducing valve which shows its two main components, the flow disc reducer on top and the main cylindrical body at the bottom, plus an optional support extender piece that fits into an optional sleeve.

FIG. 4 is a top view of the noise reducing valve's main cylindrical body.

FIG. 5 is a top view of the flow disc reducer.

FIG. 6 is a front view of the two main components of the noise reducing valve, the flow disc reducer on top and the main cylindrical body at the bottom.

FIG. 7 is a front view of the noise reducing valve similar to FIG. 6 but this time the flow disc reducer is already inserted inside the cylindrical body of the noise reducing valve. It is also showing how the valve works, by limiting incoming water flow that passes through it.

FIG. 8 is a front cross-sectional view of the same toilet during the flushing action as on FIG. 1 but this time with the noise reducing valve installed inside the bottom of the flush valve and showing a controlled flush water flow.

FIG. 9 is a side cross-sectional view of the same toilet as on FIG. 2, but this time with the noise reducing valve installed inside the cylindrical bottom piece (neck) of the toilet's flush valve, showing a controlled water flow.

FIG. 10 is a magnified cut side view of the noise reducing valve installed, as is shown in FIG. 9, where we can see details.

FIG. 11 is a cut front view of the noise reducing valve with a flow disk reducer inserted inside showing the extended support base in phantom.

FIG. 12 is a cut view of the noise reducing valve with a flow disk reducer inserted inside but showing that the cylindrical valve has no extended support base.

FIG. 13 is a sample of the flow disc reducer with an opening in oval shape.

FIG. 14 and FIG. 15 are samples of flow disc reducers with different geometric shapes.

FIG. 16 is a magnified side view of the noise reducing valve that has been built-in in a new flush valve.

FIG. 17 is a similar as in FIG. 16 but this time using a different support shape for the flow disc reducer.

FIG. 18 is a cut view of the noise reducing valve without the stand, sitting on top of the support ring inside the flush valve.

### DETAILED DESCRIPTION OF THE INVENTION

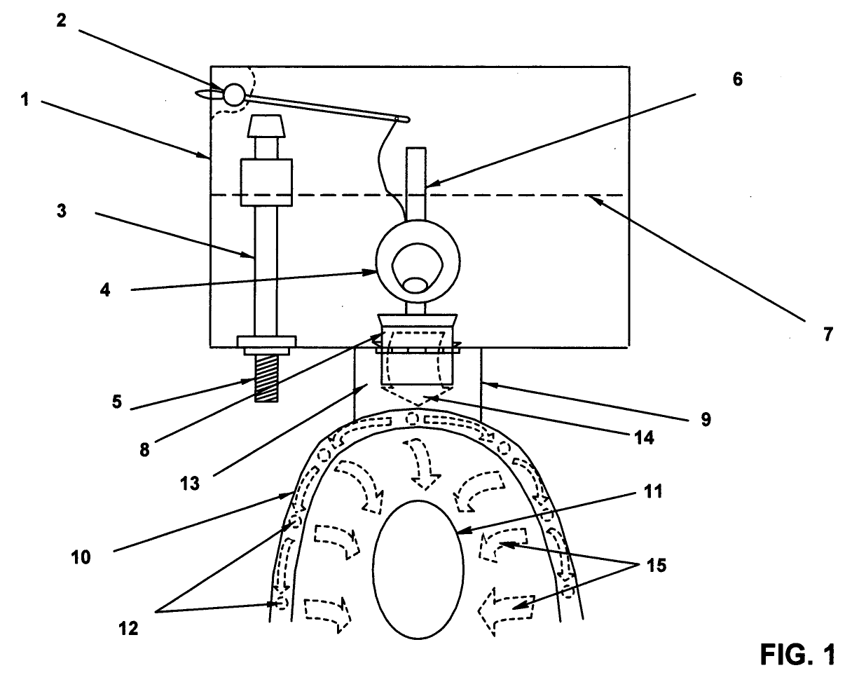

In FIG. 1 we can see a typical toilet system during the flushing action, with a storing tank 1, a handle 2 used to operate the flush valve 6 that at the bottom has a flapper 4, and the cylindrical bottom piece (neck) 8 of the flush valve 6.

The water enters the tank 1 through the bottom part 5 of the fill valve 3 which controls the maximum water level 7 inside the tank 1. The flush valve 6 interconnects between the tank 1 and the toilet bowl 10, where plenty of flush water 14 is going through the cylindrical bottom piece (neck) 8 of the flush valve 6 into the top part 9 of the toilet bowl 10 travelling inside the top chamber 13 of the toilet bowl into the jets 12, and finally the jumping flush water 15 into the toilet drain 11.

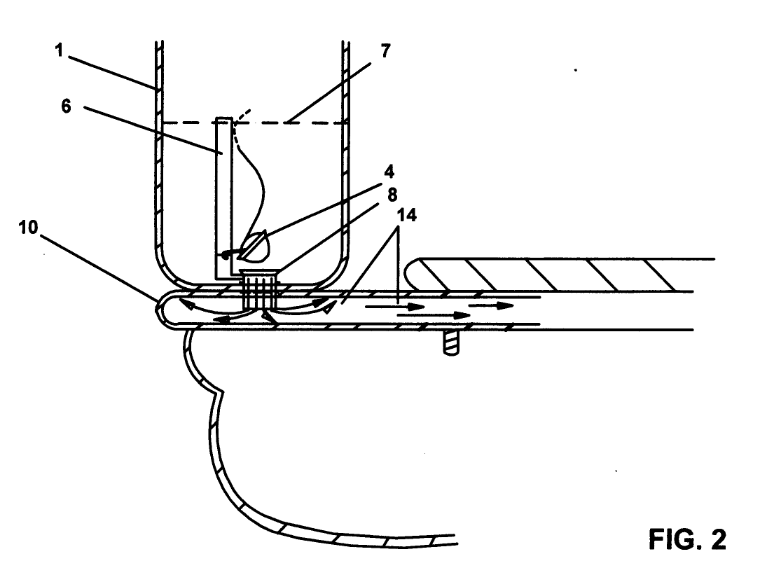

In FIG. 2 we can see a cut side view of the typical toilet system as in FIG. 1. Here, during the flushing action, when the flapper 4 of the flush valve 6 is lifted, plenty of water from the toilet tank 1 rushes through the cylindrical bottom piece (neck) 8 of the flush valve 6, lowering rapidly the water level 7 of the toilet tank 1. This allows a lot of flush water 14 to fully pass through this cylindrical bottom piece (neck) 8 of the flush valve 6 into the toilet bowl 10 into their path to the toilet jets.

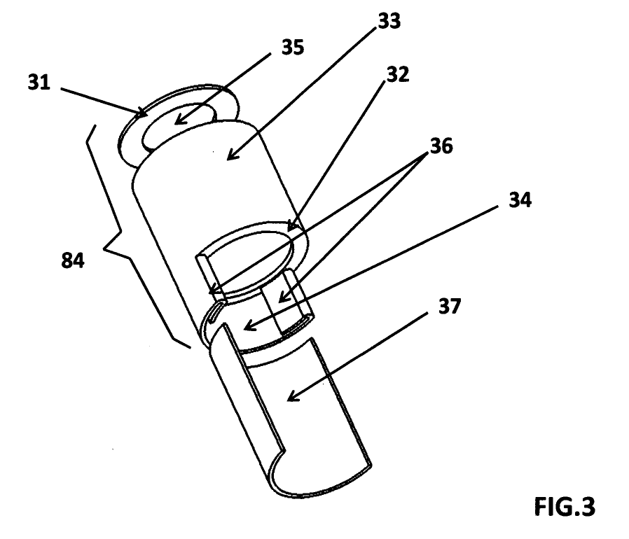

In FIG. 3 we can see the noise reducing valve 84 which has basically two main components, the main cylindrical body 33 with an extended portion of its body 34 that is used as a stand, and an internal support ring 32 that is solidly attached to the main cylindrical body 33. The solidly attached ring 32 is intended to provide support to the flow disc reducer 31, which is the second main component (more than one flow disc reducer with different opening areas could be used for fine tuning the desired water pressure).

The flow disc reducer has a central circular opening 35 that will allow a controlled amount of flush water into the noise reducing valve 84 (but enough that would provide for a good flush to the toilet). This flow disc reducer is meant to sit on this support ring 32, inside the noise reducing valve 84.

The length of the extended portion 34 is very important in the design, as it cannot be too long as the valve 84 will interfere with the flapper 4, or too small as it will not allow a proper flush water flow. Again, the length of the extended portion 34 has to be of the proper measure for a proper flush water flow.

The extended portion 34 could also have at both ends an optional sleeve 36 intended to fit and optional support extender piece 37 that could be needed for toilets with taller chambers 13 (see FIG. 1).

A very common and easy way to manufacture this valve 84 could be done by using the procedure called blow molding.

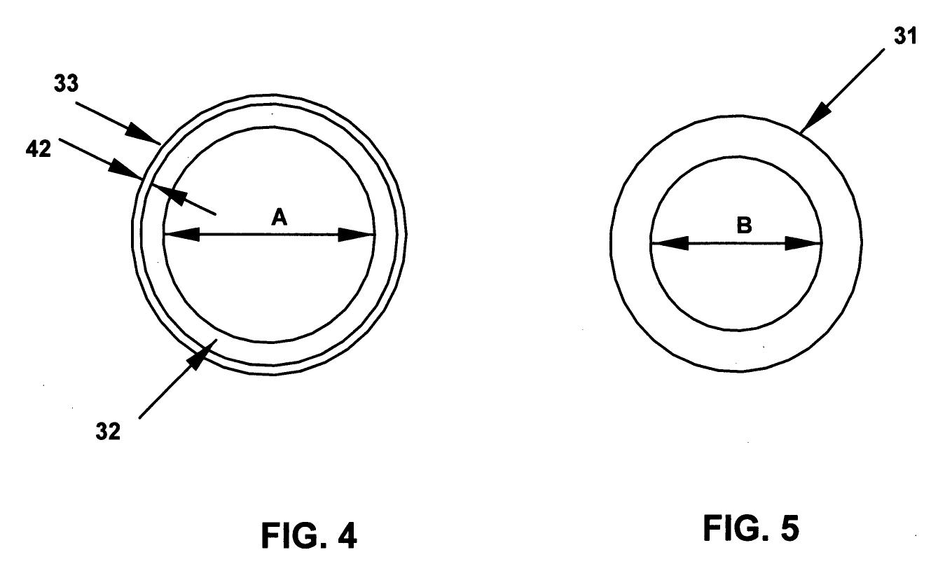

FIG. 4 is a top view of the main cylindrical body 33 of the noise reducing valve with a given thickness 42, where we can see the internal support ring 32 solidly attached to the main cylindrical body 33, that has a given diameter A, which is big enough to provide a good flush water flow by itself.

FIG. 5 shows the second component of the noise reducing valve, the water flow disc reducer 31, that is meant to have a good fit inside the valve's main cylindrical body 33 and has an internal diameter B, smaller than the diameter A in FIG. 4, which will reduce and therefore control the flush water flow and water pressure inside the toilet system, to a convenient strength, but still provide a good and smooth flush.

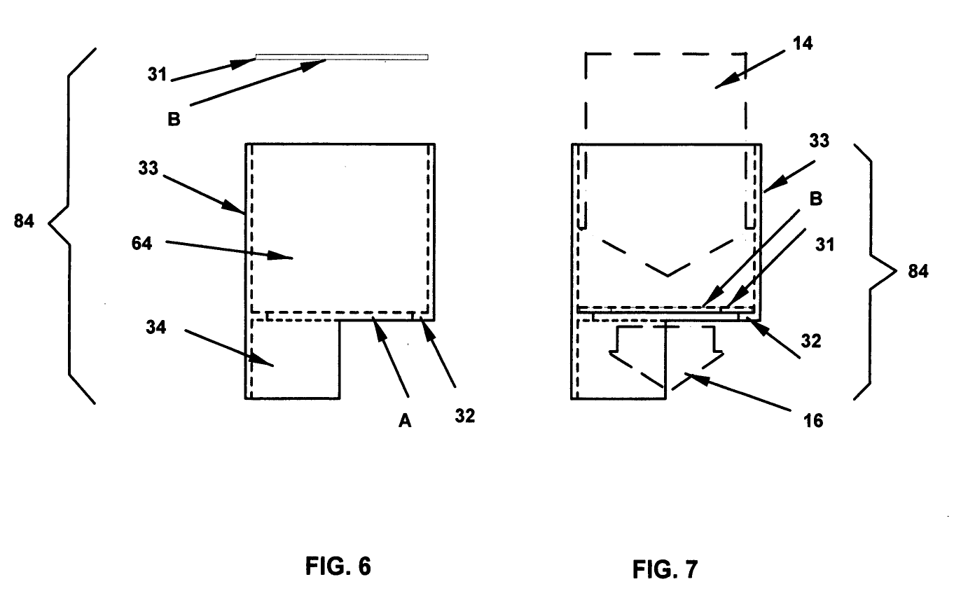

FIG. 6 shows a side view of the main cylindrical body 33 of the noise reducing valve 84 with the water flow disc reducer 31 on top, which has an opening diameter B. This flow disc reducer 31 will be placed inside the chamber 64 and will sit on top of the support ring 32 that has a bigger opening diameter A that will allow much more water flow than the flow disc reducer 1 so it does not interfere with it. This valve 84 will be supported in place by the extended portion 34, which in this case does not have the optional sleeve 36 shown in FIG. 3.

FIG. 7 shows a side view of the noise reducing valve 84 as in FIG. 6, but this time the flow disc reducer 31 is already inserted in place, inside the main cylindrical body 33 of the valve and is sitting on top of the ring 32 that is solidly attached to the valve 84. Here we can see how the noise reducing valve 84 works. The flow disc reducer 31 has an opening diameter B that will not let all the incoming tank water (arrow 14) pass through it, but only sufficient flush water flow (arrow 16) for a proper controlled flushing. By changing the opening area (its diameter) of the flow disc reducer 31 (more than one flow disc reducer 31 with different opening sizes could be used), we can control this flush water flow 16 to our convenience (fine tuning), and this will reduce the excessive water pressure and will reduce the noise level produced by the rushing water.

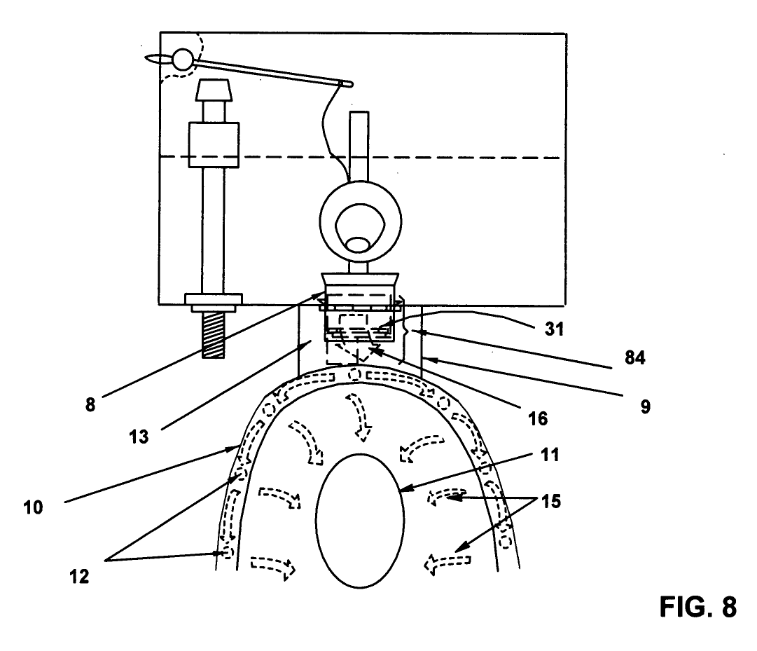

FIG. 8 shows again an example of a toilet system as in FIG. 1, but this time it has installed the noise reducing valve 84, with the flow disc reducer 31 inside the cylindrical bottom piece (neck) 8 of the flush valve 6, that is interconnecting the top portion 9 of the toilet bowl inside the chamber 13 where now only a controlled amount of flush water flow 16 runs into the bowl 10, then to the toilet jets 12 and finally the jumping flush water 15 into the toilet drain 11.

Now, this toilet will emit less noise than previously when it did not have the noise reducing valve 84 installed, and will also eliminate or minimize any splashing problem that it had before.

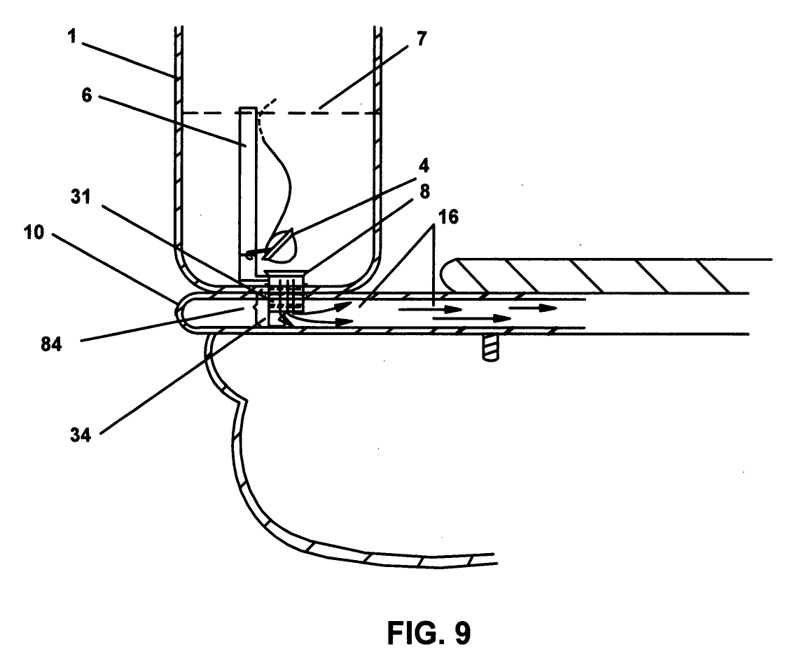

FIG. 9 is a side cut view of the toilet system of FIG. 8 where we can see how the water level 7 of the tank 1 starts to decrease, once the flapper 4 of the flush valve 6 is opened and a lower amount of flush water enters the toilet 10, thanks to our fully assembled noise reducing valve 84 that has been placed inside the cylindrical bottom piece (neck) 8 of the flush valve 6, and is sitting inside the toilet 10 thanks to its body extension 34 (that has the flow disc reducer 31 inside). The flow of flush water inside the toilet bowl 10 is now lower than previously and travels smoothly producing less noise when it exits the toilet bowl 10.

The noise reducing valve 84 for toilet systems could also come in a version without the extended stand 34.

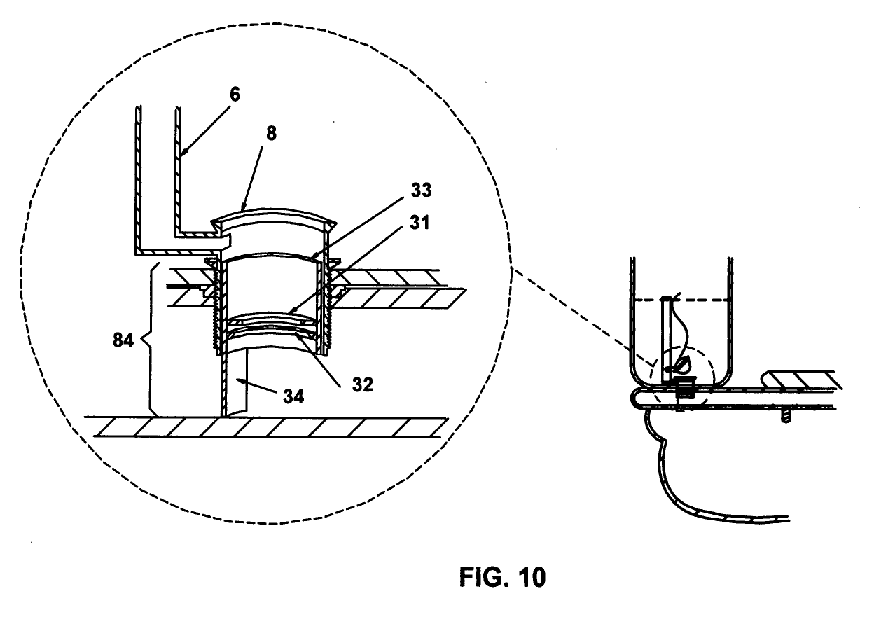

In FIG. 10 we can see a magnified cut view of the noise reducing valve 84 inside the cylindrical bottom piece (neck) 8 of the fill valve 6, where the noise reducing valve 84 is sitting inside the toilet's bowl thanks to its body extended portion 34. Also the flow disc reducer 31 is sitting on the inner support ring 32 of the main cylindrical body 33 of the noise reducing valve 84. This flow disc reducer 31 limits the flush water flow to our convenience.

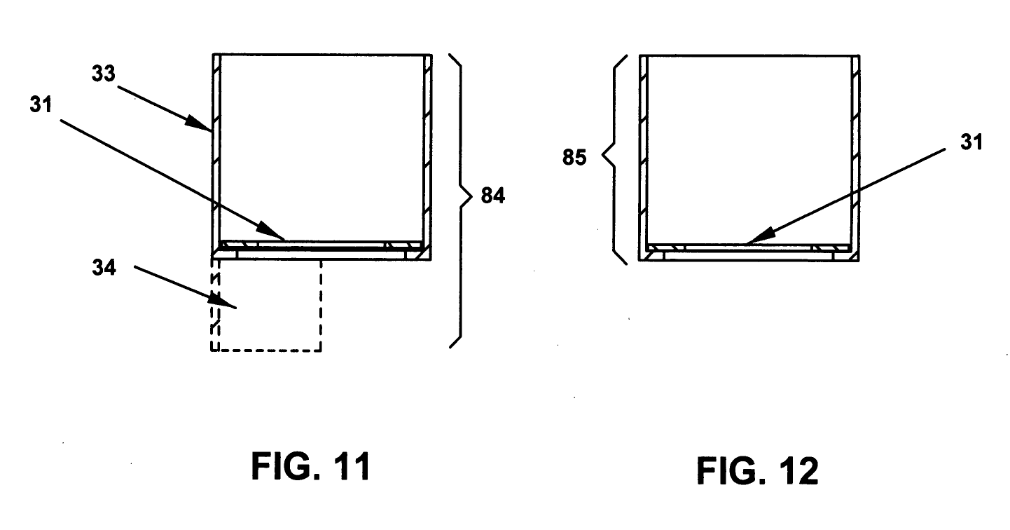

FIG. 11 is a cut front view that shows the main body of a fully assembled noise reducing valve 84 (the flow disc reducer 31 is already placed inside), and the extended bottom support part 34 in phantom as there could be applications where it might not be necessary to use it.

FIG. 12 is a front cut view that shows the noise reducing valve 85 with the disc flow reducer 31 installed with no extended support. This noise reducing valve 85 without the extended support can also be manufactured by blow molding.

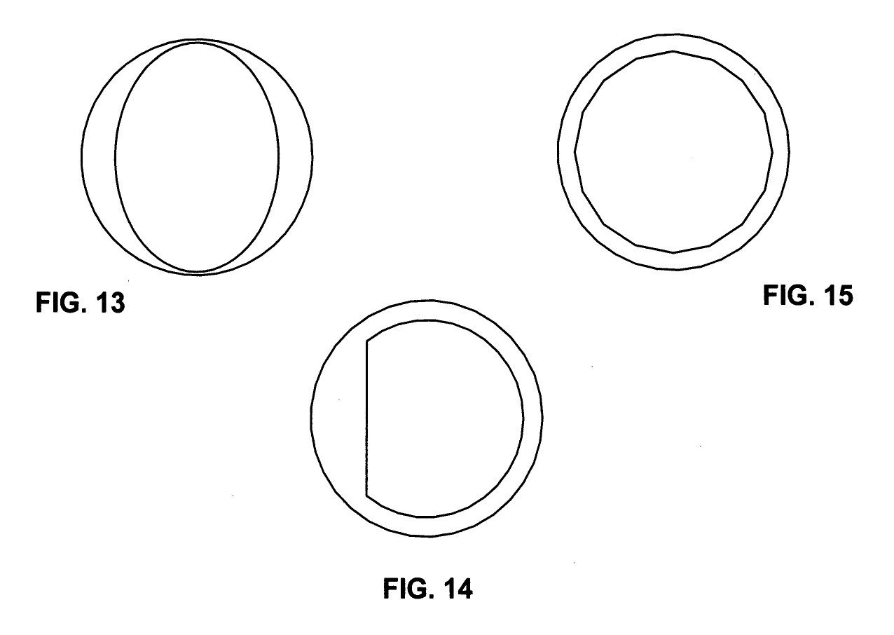

FIG. 13 shows a flow disc reducer with an opening in an oval shape instead of the circular one. Something similar can be seen in FIG. 14 and FIG. 15, where the openings of the flow disc reducers have geometric shapes different from the circular one, as many different shapes can be use for this opening.

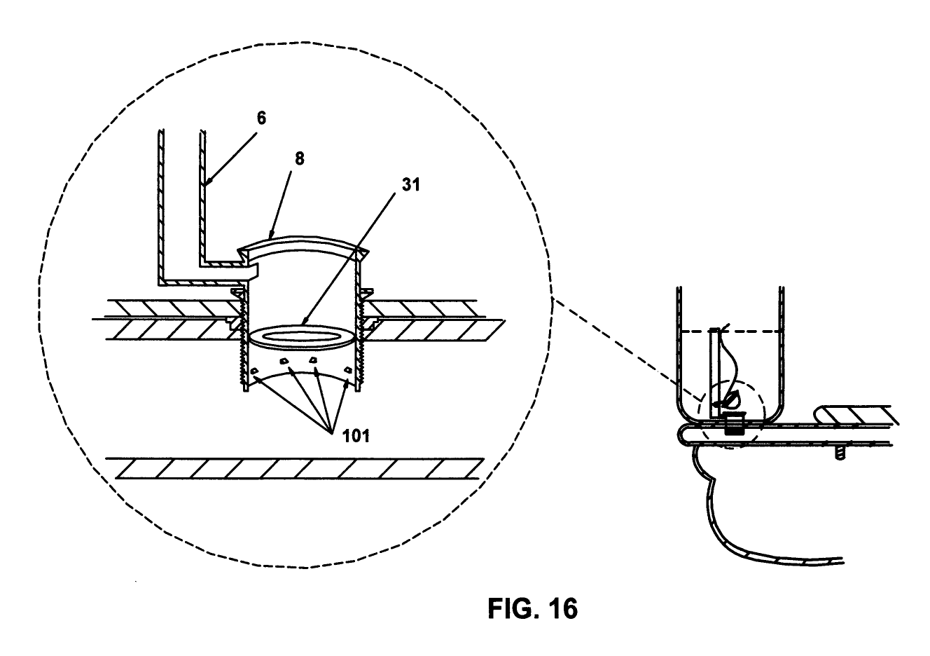

FIG. 16 shows a toilet system where the cylindrical bottom piece (neck) 8 of the flush valve 6 has been magnified in a cut view, in order to see how the noise reducing valve can be built in inside the cylindrical bottom piece (neck) 8 of the flush valve 6, and with small solidly attached pieces 101 to the inner wall of the cylindrical bottom piece (neck) 8 of the flush valve 6, in a circular arrangement, that will provide support all the flow disc reducer 31. In this case we have a dual valve that can work as a flush valve and also as a built-in noise reducing valve 8, 31, 101 by sitting the flow disc reducer 31 on the provided supports 101 in the inner wall of the cylindrical bottom piece (neck) 8.

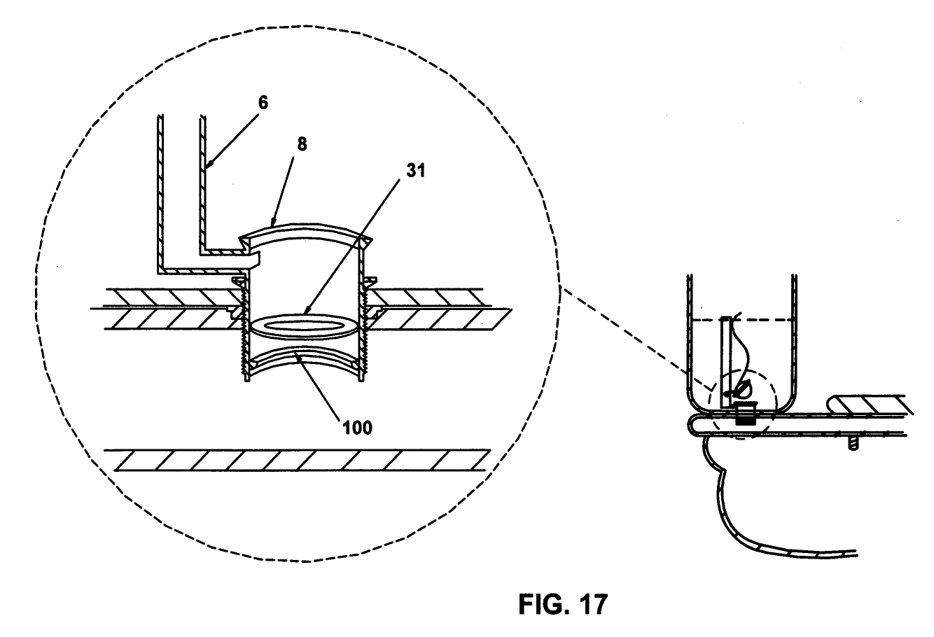

FIG. 17 is a very similar view of FIG. 16 but in this time the inner wall of the cylindrical bottom piece (neck) 8 of the flush valve 6 has a solidly attached and continuous ring shape support 100 where the flow disc reducer 31 will rest.

This built-in noise reducing valve 8, 31, 100 uses a continuous solidly attached ring support 100 for the flow disc reducer 31.

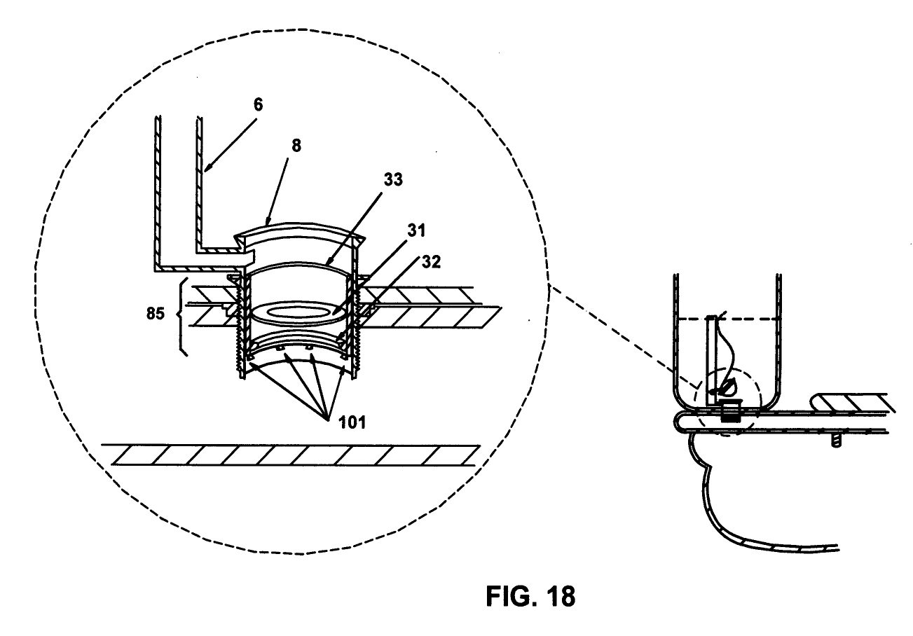

FIG. 18 is a side cut view of the noise reducing valve 85 without stand, sitting on top of the supports 101 in the inner wall of the cylindrical bottom piece 8 of the flush valve 6. Even though we could use the flow disc reducer 32 directly without the need of the main cylindrical body 33, we risk the chance that by accident the flow disc reducer 31 could fall between the supports 101 inside the toilet bowl, so in order to avoid this problem, the noise reducing valve 85 is being used.

I claim:

1. A noise reducing valve for a toilet system, comprising:
A cylindrical body;
An internal ring solidly attached to said cylindrical body;
At least one flow disc reducer
Wherein said flow disc reducer decreases the water flow of said toilet system and thereby reduces the noise generated by said toilet system; and
An optional extender piece adapted to fit into an optional sleeve.

2. The noise reducing valve of claim 1 wherein said cylindrical body has an extended portion disposed under the cylindraceous extent of said body.

3. The noise reducing valve of claim 2 wherein said extended portion rests upon the top part of the toilet bowl in said toilet system.

4. The noise reducing valve of claim 2 wherein said extended portion is integral with said body structure.

5. The noise reducing valve of claim 1 wherein said body and said internal ring are blow molded as one unit.

6. The noise reducing valve of claim 1 wherein said at least one flow disc reducer has a plurality of internal diameters forming a central circular opening through which water flows.

7. The noise reducing valve of claim 1 wherein said noise reducing valve is adapted for fine tuning of noise and water pressure.

8. The noise reducing valve of claim 1 wherein said internal ring has various internal shapes.

9. A noise reducing valve for a toilet system, comprising:
A cylindrical body;
Supports solidly attached to said cylindrical body;
At least one flow disc reducer adapted to rest upon said supports; and
An optional support extender piece that fits into an optional sleeve.

10. The noise reducing valve of claim 9 wherein said body and said supports are blow molded as one unit.

11. The noise reducing valve of claim 9 wherein said at least one flow disc reducer has a plurality of internal diameters forming a central circular opening through which water flows.

12. The noise reducing valve of claim 9 wherein said noise reducing valve is adapted for fine tuning of noise and water pressure.

13. The noise reducing valve of claim 11 wherein said supports comprise an internal ring.

14. The noise reducing valve of claim 13 wherein said supports and said internal ring have various internal shapes.

15. A noise reducing valve for a toilet system comprising:
A toilet having a neck;
Supports solidly attached to said neck; and
At least one flow disc reducer adapted to rest upon said supports and adapted to allow variable water flow.

16. The noise reducing valve of claim 15 wherein said supports are integral to the structure of said toilet and said neck.

17. The noise reducing valve of claim 15 wherein said neck and said supports are blow molded as one unit.

18. The noise reducing valve of claim 15 wherein said at least one flow disc reducer has a plurality of internal diameters forming a central circular opening through which water flows.

19. The noise reducing valve of claim 15 wherein said noise reducing valve is adapted for fine tuning of noise and water pressure.

20. The noise reducing valve of claim 18 wherein said at least one flow disc reducer has various internal shapes.
